(19) United States
(12) Patent Application Publication
(10) Pub. No.: US 2013/0084404 A1
(43) Pub. Date: Apr. 4, 2013

(54) APPARATUSES AND METHODS FOR TREATING SUBSTRATE

(71) Applicant: Chul Ho PARK, Cheonan-si (KR)

(72) Inventor: Chul Ho PARK, Cheonan-si (KR)

(73) Assignee: SEMES CO., LTD., Cheonan-si (KR)

(21) Appl. No.: 13/606,628

(22) Filed: Sep. 7, 2012

(30) Foreign Application Priority Data
Sep. 30, 2011 (KR) 10-2011-0099835
Dec. 27, 2011 (KR) 10-2011-0143128

(51) Int. Cl. B05D 1/26; B05D 3/06; B05C 5/02

(52) U.S. Cl. 427/553; 118/58; 118/620; 427/286

(57) ABSTRACT

Provided is an apparatus and method for treating a substrate, and more particularly, an apparatus and method for treating a substrate which performs a patterning process. The substrate treating apparatus includes a stage on which a substrate is placed, a discharge unit that discharges ink to form lines on the substrate placed on the stage, a solidifying unit that solidifies the discharged ink, and a transfer unit moving the stage or moving the discharge unit and the solidifying unit.

### CROSS-REFERENCE TO RELATED APPLICATIONS

This U.S. non-provisional patent application claims priority under 35 U.S.C. §119 of Korean Patent Application Nos. 10-2011-0099835, filed on Sep. 30, 2011, and 10-2011-0143128, filed on Dec. 27, 2011, the entire contents of which are hereby incorporated by reference.

### BACKGROUND OF THE INVENTION

The present invention disclosed herein relates to an apparatus and method for treating a substrate, and more particularly, to an apparatus and method for treating a substrate which performs a direct write type printing process.

Photolithography processes for fabricating circuit lines used in a printed circuit board (PCB) or a flat panel display (FPD) are increasingly being replaced with direct write type printing processes.

Direct write type printing processes are simple and provide high substrate throughput since circuit lines are directly formed on a substrate. In addition, direct write type printing processes are environmentally friendly since the use of chemicals is minimized unlike in photolithography processes. However, since precise control of ink thickness is difficult, the use of direct write type printing processes is limited.

Furthermore, a recently introduced electrohydraulic method makes it possible to control ink in a liquid column having a minute thickness. Thus, direct write type printing processes can be used in typical PCB or FPD fabrication processes, and further, will be used in semiconductor device fabrication processes.

### Patent Document

Korean Patent Registration No. 10-1000715 (registered on Dec. 6, 2010)

### SUMMARY OF THE INVENTION

The present invention provides an apparatus and method for treating a substrate, which forms and solidifies a line on a substrate through a single process.

However, the present invention is not limited thereto, and thus, other apparatuses and methods for treating a substrate not described herein would be clearly understood by those skilled in the art from the following descriptions and the accompanying drawings.

Embodiments of the present invention provide substrate treating apparatuses including: a stage on which a substrate is placed; a discharge unit that discharges ink to form lines on the substrate placed on the stage; a solidifying unit that solidifies the discharged ink; and a transfer unit moving the stage or moving the discharge unit and the solidifying unit.

In some embodiments, the discharge unit and the solidifying unit may be arrayed in line in a moving direction thereof above the stage.

In other embodiments, the solidifying unit may include an irradiation member that emits light.

In still other embodiments, the irradiation member may be provided in plurality, and the irradiation members may be in one-to-one correspondence to the lines to emit the light thereto.

In even other embodiments, the irradiation member may be provided in a slit form having a width corresponding to a width of all the lines, and emit the light to a region corresponding to the width of all the lines.

In yet other embodiments, the irradiation member may emit the light in a direction inclined from a vertical downward direction to a moving direction thereof.

In further embodiments, the irradiation member may emit a laser or an ultraviolet ray.

In still further embodiments, the solidifying unit may include a heating member that generates heat.

In even further embodiments, the solidifying unit may include a spraying member for spraying high temperature infusible particles or high temperature gas.

In yet further embodiments, the discharge unit may include nozzles, each of which discharges the ink.

In much further embodiments, the substrate treating apparatuses may further include a power unit applying a high voltage to the discharge unit, wherein the nozzles are provided in the form of a minute needle, and discharge the ink in a liquid column shape according to the high voltage by using an electrohydrodynamic method.

In even much further embodiments, the substrate treating apparatuses may further include a rotation unit rotating the stage.

In yet much further embodiments, the ink may be conductive ink.

In other embodiments of the present invention, substrate treating methods include: placing a substrate on a stage; discharging ink by a discharge unit horizontally moving above the stage, to form first lines on the substrate placed on the stage; and solidifying the discharged ink by a solidifying unit following the discharge unit.

In some embodiments, in the solidifying of the discharge ink, light may be emitted to the discharged ink to solidify the ink.

In other embodiments, in the solidifying of the discharge ink, the light may be emitted such that beams thereof are in one-to-one correspondence to the first lines.

In still other embodiments, in the solidifying of the discharge ink, the light may be emitted to a region corresponding to a width of all the first lines.

In even other embodiments, in the solidifying of the discharge ink, the light may be emitted in a direction inclined from a vertical downward direction to a moving direction thereof.

In yet other embodiments, the substrate treating methods may further include applying a high voltage to the discharge unit, wherein in the forming of the first lines, nozzles included in the discharge unit and provided in the form of a minute needle discharge the ink in a liquid column shape according to the high voltage by using an electrohydrodynamic method.

In further embodiments, the substrate treating methods may further include: rotating the stage through about 90 degrees; discharging the ink by the discharge unit horizontally moving above the stage, to form second lines perpendicular to the first lines formed on the substrate; and solidifying the second lines of the discharged ink by the solidifying unit following the discharge unit.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a perspective view illustrating a substrate treating apparatus according to an embodiment of the present invention;

FIG. 2 is a perspective view illustrating a discharge unit of FIG. 1;

FIG. 3 is a cross-sectional view illustrating an operation of the discharge unit of FIG. 2;

FIG. 4 is a perspective view illustrating a solidifying unit of FIG. 1;

FIG. 5 is a bottom view illustrating the solidifying unit of FIG. 4;

FIG. 6 is a cross-sectional view illustrating an operation of the solidifying unit of FIG. 4;

FIG. 7 is a perspective view illustrating a solidifying unit according to another embodiment of the present invention;

FIG. 8 is a bottom view illustrating the solidifying unit of FIG. 7;

FIGS. 9 and 10 are cross-sectional views illustrating an operation of the solidifying unit of FIG. 1;

FIG. 11 is a flowchart illustrating a substrate treating method according to another embodiment of the present invention;

FIGS. 12 and 13 are perspective views illustrating the substrate treating method of FIG. 11; and

FIGS. 14 and 15 are perspective views illustrating subsequent processes of the substrate treating method of FIG. 11.

### DETAILED DESCRIPTION OF PREFERRED EMBODIMENTS

The terms and accompanying drawings used herein are exemplary terms and drawings for describing exemplary embodiments of the present invention, and thus, the present invention is not limited thereto.

Moreover, detailed descriptions related to well-known technologies will be ruled out in order not to unnecessarily obscure subject matters of the present invention.

Hereinafter, a substrate treating apparatus 100 according to the present invention will now be described.

The substrate treating apparatus 100 uses a direct write method to directly form a pattern on a substrate S. The substrate treating apparatus 100 may treat printed circuit boards, transparent substrates used in a flat panel display, such as glass substrates, and various wafers used to fabricate a semiconductor device. For example, the substrate treating apparatus 100 may form conductive ink in a line shape on a glass substrate to form a transparent electrode line of a flat panel display.

Hereinafter, a substrate treating apparatus 100 according to an embodiment of the present invention will now be described.

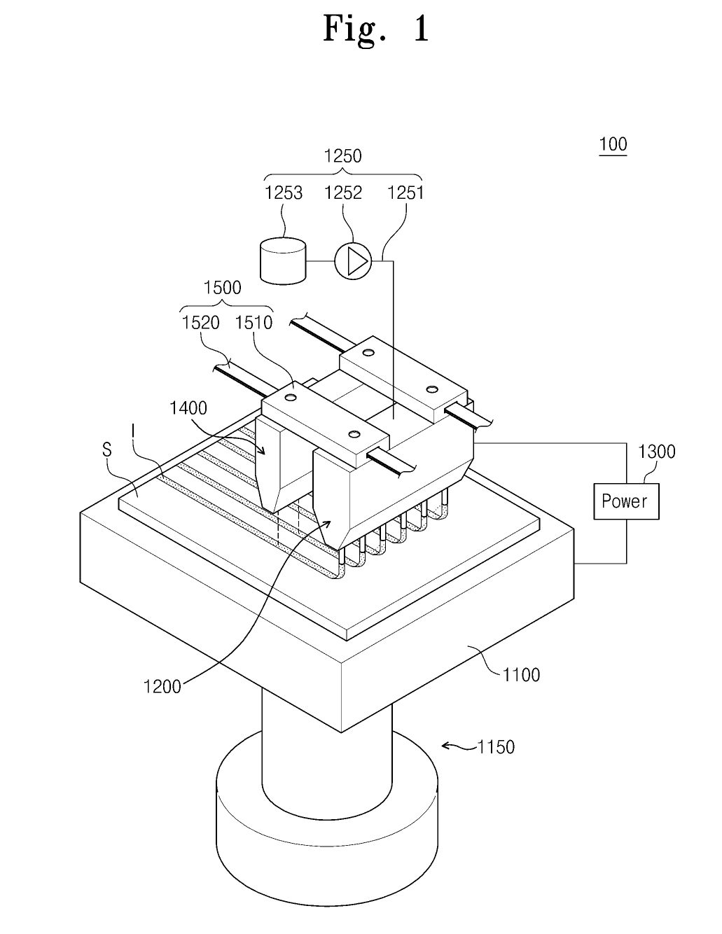

FIG. 1 is a perspective view illustrating the substrate treating apparatus 100.

Referring to FIG. 1, the substrate treating apparatus 100 may include a stage 1100, a discharge unit 1200, a solidifying unit 1400, and a transfer unit 1500.

The stage 1100 supports a substrate S. The substrate S may be transferred to the substrate treating apparatus 100 from the outside thereof, and be placed on the stage 1100.

The top surface of the stage 1100 may have a shape that is similar to or the same as that of the substrate S, and an area that is greater than that of the substrate S. For example, when a glass substrate used to fabricate a flat panel display is treated, the stage 1100 may have a tetragonal shape having an area greater than that of the glass substrate.

The discharge unit 1200 discharges ink I. The ink I may be conductive ink. The type and ingredients of the ink I may be appropriately varied according to processes using the substrate treating apparatus 100.

The discharge unit 1200 is disposed above the stage 1100. The discharge unit 1200 may discharge ink I onto the top surface of the substrate S placed on the stage 1100.

The discharge unit 1200 may be moved horizontally. When the discharge unit 1200 horizontally moves over the stage 1100 and discharges the ink I, a line may be formed in a moving direction of the discharge unit 1200, on the top surface of the substrate S placed on the stage 1100. The line may be one of various circuit lines. For example, a line formed of conductive ink may be a transparent electrode line of a flat panel display.

The discharge unit 200 may use various methods to discharge the ink I. For example, a drop on demand (DOD) type inkjet method such as a continuous jetting (CJ) method, a piezo inkjet method, or a thermal inkjet method; or an electrohydrodynamic method may be used to discharge the ink I. Hereinafter, the electrohydrodynamic method is exemplified for convenience in description. However, methods used by the discharge unit 1200 to discharge the ink I are not limited to the electrohydrodynamic method, and thus, not only the above described methods but also other methods may be used.

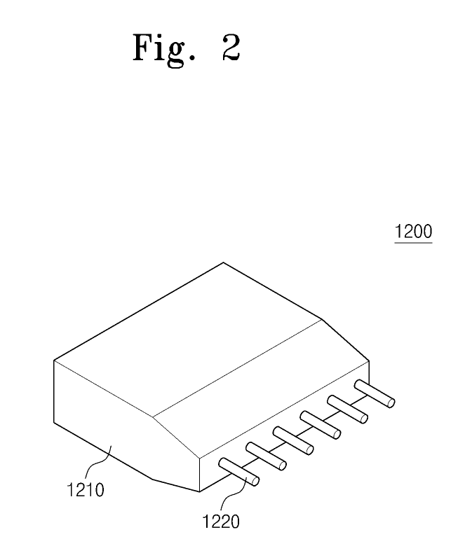

FIG. 2 is a perspective view illustrating the discharge unit 1200 of FIG. 1.

Referring to FIG. 2, the discharge unit 1200 may include a body 1210 and nozzles 1220.

The body 1210 is disposed above the stage 1100. The body 1210 may be coupled to the transfer unit 1500, and be horizontally moved by the transfer unit 1500. A width of the body 1210, perpendicular to a moving direction thereof, may be equal to or close to the width of the stage 1100 or the width of the substrate S placed on the stage 1100.

The ink I may be supplied to the body 1210 from an ink supply unit 1250. The ink supply unit 1250 may be provided as a component of the substrate treating apparatus 100, or be provided as a separate external unit.

The ink supply unit 1250 may include an ink storage 1253, a pump 1252, and a supply line 1251. The ink storage 1253 stores the ink I. The supply line 1251 connects the ink storage 1253 to the body 1210. The pump 1252 may be installed on the supply line 1251 to control a flow rate of the ink I supplied from the ink storage 1253 to the body 1210 through the supply line 1251. The body 1210 may be provided in the form of a tank having an inner space. The ink I supplied from the ink supply unit 1250 may be stored in the inner space of the body 1210, and be provided to the nozzles 1220.

The nozzles 1220 discharge the ink I. The nozzles 1220 may discharge the ink I supplied from the ink supply unit 1250 to the body 1210.

The nozzles 1220 are disposed on the bottom surface of the body 1210, and discharge the ink Ito the top surface of the substrate S placed on the stage 1100. While the body 1210 is moved, the nozzles 1220 discharge the ink I on the top surface of the substrate S so as to form a line.

At least one of the nozzles 1220 may be provided. The nozzles 1220 disposed on the bottom surface of the body 1210 may be arrayed at a constant interval in a direction perpendicular to the moving direction of the body 1210. In this configuration, the discharge unit 1200 can form a plurality of lines on the top surface of the substrate S.

When the ink I is discharged using the electrohydrodynamic method, the substrate treating apparatus 100 may include a power unit 1300.

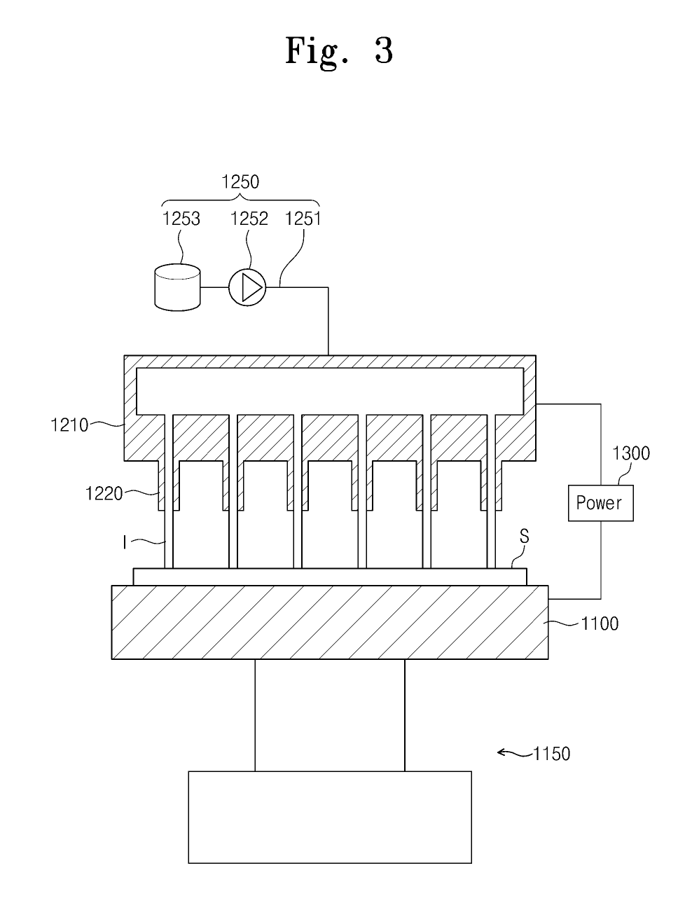

FIG. 3 is a cross-sectional view illustrating an operation of the discharge unit 1200 of FIG. 2.

Referring to FIG. 3, the power unit 1300 generates a high voltage. An end of the power unit 1300 may be connected to the body 1210, and another end thereof may be connected to the stage 1100. The power unit 1300 may apply a high voltage to the body 1210. The stage 1100 may be negatively charged by the power unit 1300, or be grounded.

The stage 1100 may be formed of a conductive material such as a metal. Thus, an electric field according to a high voltage can be generated between the body 1210 and the stage 1100.

Each of the nozzles 1220, which has a through hole with a minute inner diameter, may be provided in the form of a hollow needle having a tube structure. The through hole may have a cylindrical shape with a constant inner diameter in the vertical direction thereof, or a conical or hemispherical shape decreasing in inner diameter from the upper side of the nozzle 1220 to the lower side.

A high voltage may be applied to the nozzles 1220 through the body 1210. The body 1210 and the nozzles 1220 may be formed of a material of having high electrical conductivity. For example, the body 1210 and the nozzles 1220 may be formed of a metal.

When a high voltage is applied to the nozzles 1220, the high voltage may also be applied to the ink I discharged through the nozzles 1220. Then, particles of the ink I are electrically charged to generate repulsive force therebetween. Accordingly, droplets of the ink I which have a conical shape decreasing in diameter from the upper side of the nozzle 1220 to the lower side thereof, are discharged through ends of the nozzles 1220. When an electric field is applied to the discharged droplet having a conical shape, the lower part of the conical shape is maintained in a stable liquid column shape having a minute diameter and is supplied onto the substrate S. That is, the discharge unit 1200 discharges the ink I in a liquid column shape having a minute diameter, to thereby form a line having a minute thickness on the top surface of the substrate S.

The power unit 1300 may adjust a high voltage to be applied to the body 1210. When a voltage applied to the body 1210 is increased, the strength of an electric field is increased so as to decrease the diameter of a liquid column. On the contrary, when a voltage applied to the body 1210 is decreased, the strength of an electric field is decreased so as to increase the diameter of a liquid column. When a voltage applied to the body 1210 exceeds a critical value, repulsive force between charged particles of the ink I may be increased, and thus, micro particles or nano particles of the ink I may be discharged in an electrospray manner through the nozzles 1220.

The solidifying unit 1400 may solidify the ink I. The solidification of the ink I means evaporating a solvent from the ink I to thereby fix the ink I onto the substrate S. Furthermore, the solidification is an inclusive concept including drying of the ink I and sintering of the ink I.

The arrangement of particles of the ink I may be varied according to a solidification speed or a temperature. For example, when a solidification speed is low, particles have no pore and are evenly arrayed. On the contrary, when a solidification speed is high, particles of the ink I are unevenly arrayed and have pores so as to increase porosity, and density deviation of the particles occurs in the ink I. Particularly, since pores of conductive ink function as resistors, when a solidification speed is high, the performance of a circuit line formed of the conductive ink may be degraded.

The solidifying unit 1400 is disposed above the stage 1100. The solidifying unit 1400 may be spaced apart from the discharge unit 1200 in the moving direction of the body 1210. In this case, the discharge unit 1200 may be disposed at the front in the moving direction of the body 1210, and the solidifying unit 1400 may be disposed at the rear in the moving direction of the body 1210.

The solidifying unit 1400 and the discharge unit 1200 may be moved in the same direction. Since the solidifying unit 1400 is disposed behind the discharge unit 1200, the solidifying unit 1400 may follows the discharge unit 1200. Accordingly, the solidifying unit 1400 may solidify the ink I discharged by the discharge unit 1200.

The solidifying unit 1400 may use various methods to solidify the ink I. For example, the solidifying unit 1400 may be provided as a heating member for generating heat, e.g., a heater. In this case, the heater may heat the ink I discharged onto the substrate S. Accordingly, a solvent is evaporated from the ink I, and thus, the ink I is solidified. For another example, the solidifying unit 1400 may be provided as a spraying member for spraying high temperature infusible particles or high temperature gas, e.g., a nozzle. In this case, the spraying member may receive high temperature infusible particles or high temperature gas from the outside, and spray the high temperature infusible particles or high temperature gas to the ink I discharged onto the substrate S. Alternatively, the spraying member may receive infusible particles or gas from the outside, and heat the infusible particles or gas to spray the infusible particles or gas to the ink I discharged onto the substrate S. Accordingly, heat is transferred to the ink I to evaporate a solvent, thereby solidifying the ink I. For another example, the solidifying unit 1400 may emit light to solidify the ink I. Hereinafter, the solidifying unit 1400 is exemplified as an irradiation device for solidifying the ink I, for convenience in description. However, methods used by the solidifying unit 1400 to solidify the ink I are not limited to an irradiation method, and thus, not only the above described methods but also other methods may be used.

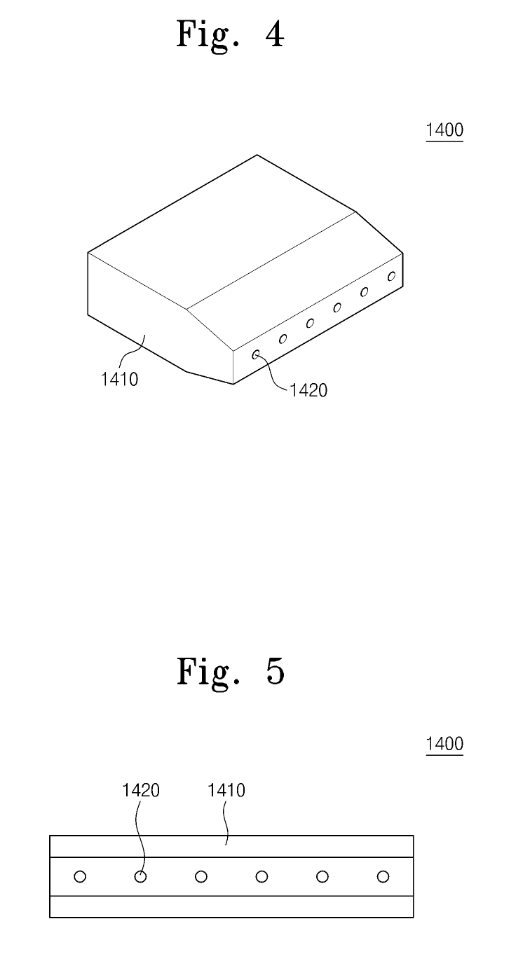

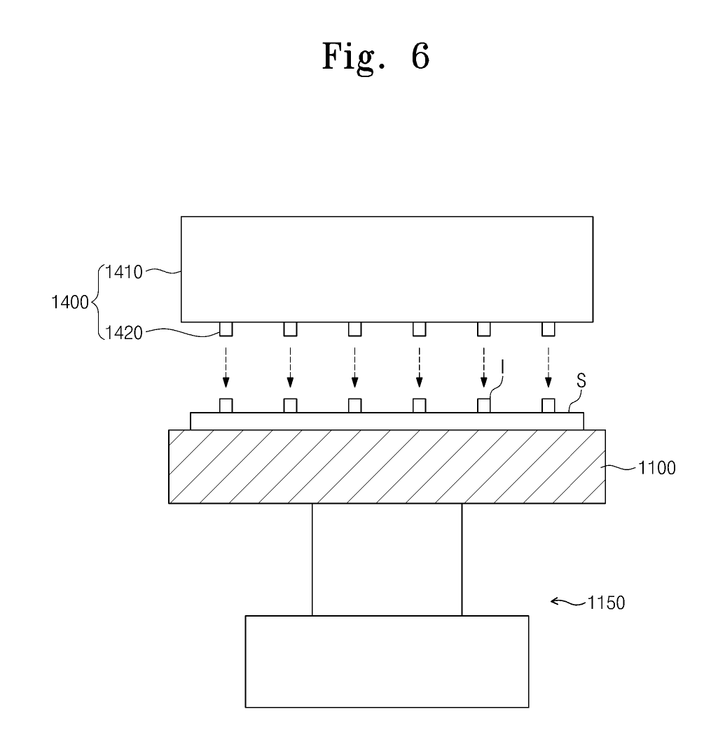

FIG. 4 is a perspective view illustrating the solidifying unit 1400 of FIG. 1. FIG. 5 is a bottom view illustrating the solidifying unit 1400 of FIG. 4.

The solidifying unit 1400 may include a body 1410 and an irradiation member 1420.

Referring to FIGS. 4 and 5, the body 1410 is disposed above the stage 1100.

The body 1410 may be spaced rearward from the body 1210 of the discharge unit 1200 by a predetermined distance in the moving direction thereof. The body 1410 may be coupled to the transfer unit 1500, and be horizontally moved by the transfer unit 1500. The body 1410 and the body 1210 may be moved in the same direction. Accordingly, the body 1410 may follow the body 1210.

A width of the body 1410, perpendicular to a moving direction thereof, may be equal to or close to the width of the stage 1100 or the width of the substrate S placed on the stage 1100. The width of the body 1410 may be the same as that of the body 1210.

The irradiation member 1420 emits light. In this case, the light may be a laser or an ultraviolet (UV) ray. The irradiation member 1420 may be disposed on the bottom surface of the body 1410, and emit light to the substrate S placed on the stage 1100.

When light is emitted to the ink I discharged on the top surface of the substrate S, a solvent is evaporated from the ink I to thereby sinter the ink I. In detail, when light such as a laser is emitted to the ink I, heat is transferred thereto. When the ink I is conductive ink, heat is transferred from light to the ink I to evaporate a solvent and sinter a solute including metal particles such as silver. When the heat transferred from the light heats the metal particles to a high temperature, the metal particles are temporarily molten and are then solidified through agglomeration. Thus, when the ink I is solidified using light, a line having a uniform density can be formed.

The irradiation member 1420 may be provided in plurality. The irradiation members 1420 disposed on the bottom surface of the body 1410 may be arrayed at a constant interval in a direction perpendicular to the moving direction of the body 1410. The interval of the irradiation members 1420 may be the same as that of the nozzles 1220 of the discharge unit 1200. The irradiation members 1420 may be in one-to-one correspondence to the nozzles 1220. For example, in plan view, each of the irradiation members 1420 and the corresponding nozzle 1220 may be located on the same straight line in the moving direction thereof. Accordingly, moving paths of the nozzles 1220 may be in one-to-one correspondence to moving paths of the irradiation members 1420, and overlap the moving paths of the irradiation members 1420, respectively.

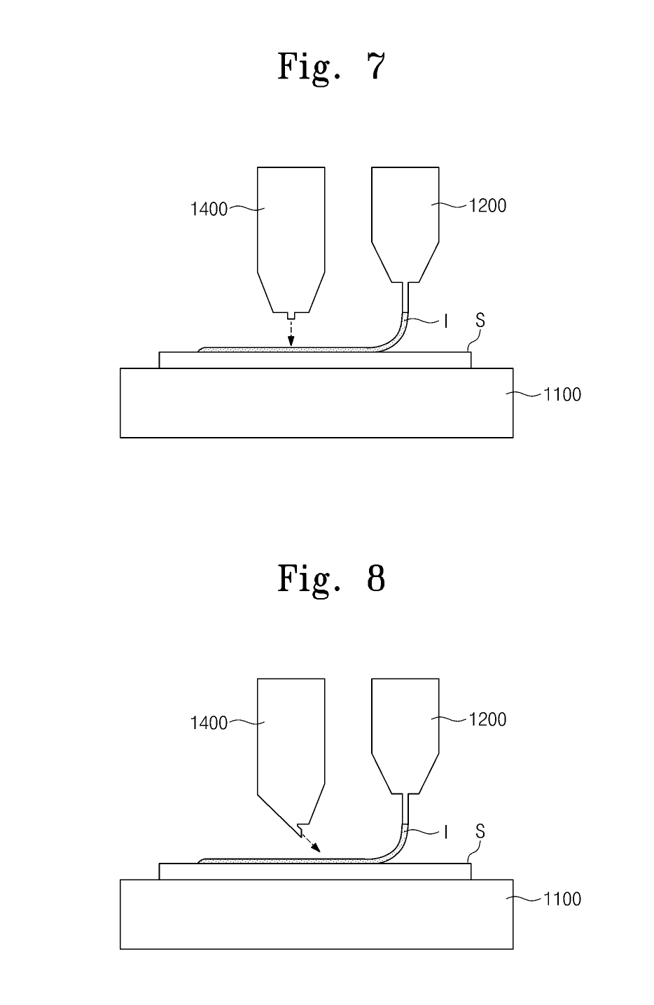

FIG. 6 is a cross-sectional view illustrating an operation of the solidifying unit 1400 of FIG. 4.

Referring to FIG. 6, the irradiation members 1420 may be in one-to-one correspondence to lines formed from the ink I discharged by the nozzles 1220, to emit light to the lines. Then, the light supplies energy to the lines of the ink Ito dry or sinter the ink I, thereby solidifying the ink I. In this case, the light is emitted to only the lines and is not emitted to the outer surface of the substrate S. Thus, the substrate S and patterns out of the lines of the ink I can be protected from the emitted light.

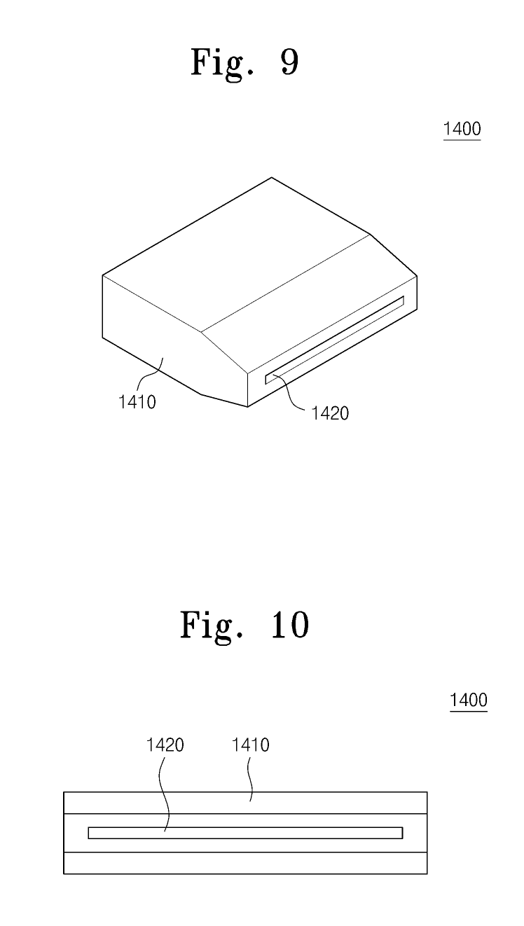

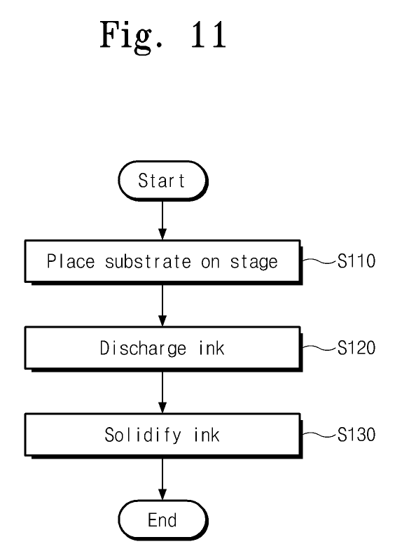

FIG. 7 is a perspective view illustrating a solidifying unit 1400 according to another embodiment of the present invention. FIG. 8 is a bottom view illustrating the solidifying unit 1400 of FIG. 7.

According to the current embodiment, the solidifying unit 1400 may include an irradiation member 1420 having a slit shape.

Referring to FIGS. 7 and 8, the irradiation member 1420 may be disposed on the bottom surface of a body 1410, and be extended in a direction perpendicular to a moving direction thereof. The irradiation member 1420 may emit light through the entire surface of the slit shape thereof.

The width of the slit shape may be substantially equal to that of the body 1410. Alternatively, the width of the slit shape may correspond to that of the nozzles 1220. That is, the width of the irradiation member 1420 may correspond to the distance between the two outermost ones of the nozzles 1220. Thus, the irradiation member 1420 emits light to a region corresponding to the width of all lines of ink I formed on the substrate S, thereby solidifying the ink I.

Alternatively, the irradiation member 1420 may be provided plurality. For example, the body 1410 illustrated in FIGS. 7 and 8 may be provided with two slit type irradiation members 1420 having a length that is half the length of the irradiation member 1420 illustrated in FIGS. 7 and 8.

The solidifying unit 1400 may emit light in a vertical downward direction thereof, or in a direction inclined from the vertical downward direction to a moving direction thereof.

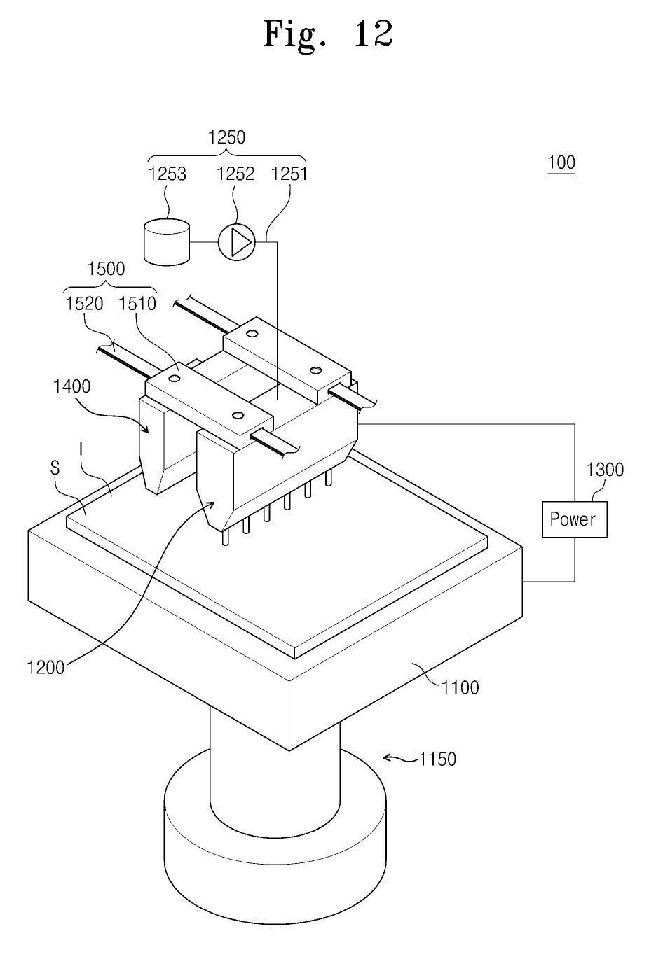

FIGS. 9 and 10 are cross-sectional views illustrating an operation of the solidifying unit 1400 of FIG. 1.

Referring to FIG. 9, the irradiation member 1420 may emit light in a vertical downward direction.

Accordingly, the ink I discharged onto the substrate S is solidified by the emitted light.

Referring to FIG. 10, the irradiation member 1420 may emit light in a direction inclined forward from the vertical downward direction. In this case, a time interval from a point of time when the ink I is discharged to a point of time when the ink I is solidified by emitted light can be decreased than in the case of FIG. 9.

The solidifying unit 1400 may include an irradiation direction adjusting member for adjusting an irradiation direction of the irradiation member 1420. The irradiation direction adjusting member may control an orientation of the irradiation member 1420 to emit light in a direction inclined from the vertical downward direction to the moving direction thereof or from the vertical downward direction to a direction opposite to the moving direction.

As such, an angle at which the solidifying unit 1400 emits light may be determined according to various process conditions such as the type of the ink I and the distance between the discharge unit 1200 and the solidifying unit 1400.

The transfer unit 1500 may horizontally move the discharge unit 1200 and the solidifying unit 1400. The transfer unit 1500 may include a transfer 1510 and a transfer frame 1520. The transfer frame 1520 may be horizontally extended above the stage 1100. The transfer 1510 may be coupled to the transfer frame 1520, and be moved along the transfer frame 1520. The discharge unit 1200 and the solidifying unit 1400 may be coupled to the transfer 1510, and be spaced a predetermined distance from each other in line in a transfer direction. Thus, the discharge unit 1200 and the solidifying unit 1400 can be horizontally moved above the stage 1100 by the transfer unit 1500.

The transfer unit 1500 may move the stage 1100 instead of the discharge unit 1200 and the solidifying unit 1400. In this case, the substrate S placed on the stage 1100 can be horizontally moved relative to the discharge unit 1200 and the solidifying unit 1400. Alternatively, the transfer unit 1500 may move only the substrate S.

As such, while the transfer unit 1500 moves the discharge unit 1200 and the solidifying unit 1400, the stage 1100, or the substrate S in a moving direction, the ink I may be discharged onto the substrate S, and the discharged ink I may be solidified to form lines according to the moving direction.

The substrate treating apparatus 100 may include a rotation member 1150.

The rotation member 1150 may rotate the stage 1100. For example, the rotation member 1150 may include a rotation shaft and a motor. The motor generates torque. An end of the rotation shaft is coupled to the stage 1100, and the other end thereof is connected to the motor. Thus, the stage 1100 can be rotated according to torque from the motor. Accordingly, the substrate S is rotated. Then, the discharge unit 1200 and the solidifying unit 1400 can form lines rotated through a rotation angle of the substrate S.

For example, when the substrate treating apparatus 100 forms a first line on the substrate S in a moving direction, and then, the rotation member 1150 rotates the stage 1100 through about 90 degrees, the substrate treating apparatus 100 can form a second line perpendicular to the first line, on the substrate S. Accordingly, a lattice pattern can be formed on the substrate S. The first line may function as a source electrode line of a flat panel display, and the second line may function as a gate electrode line thereof.

Instead of rotating the stage 1100, the rotation member 1150 may rotate the transfer unit 1500, or the discharge unit 1200 and the solidifying unit 1400. Also in this case, the substrate treating apparatus 100 can form lines rotated through a rotation angle of the substrate S.

The substrate treating apparatus 100 may include a controller. The controller may control components of the substrate treating apparatus 100. For example, the controller may control movement of the transfer unit 1500. For another example, the controller may control the magnitude of voltage applied by the power unit 1300. For another example, the controller may control a flow rate at the discharge unit 1200, or control whether the irradiation member 1420 of the solidifying unit 1400 emit light. For another example, the controller may control the rotation member 1150 to rotate the stage 1100.

The controller may be a computer or an equivalent thereof, which includes a hardware, a software, or a combination thereof.

With respect to the hardware, the controller may include application specific integrated circuits (ASICs), digital signal processors (DSPs), digital signal processing devices (DSPDs), programmable logic devices (PLDs), field programmable gate arrays (FPGAs), processors, micro-controllers, microprocessors, or an electrical device having a control function similar to that of the above examples.

With respect to the hardware, the controller may include a software code or software application written in one or more program languages. The software may be executed by a control part as a hardware. The software may be transmitted from an external device such as a server, and be installed on the hardware of the controller.

Hereinafter, a substrate treating method according to the present invention, using the above described substrate treating apparatus 100, will now be described. However, this is for convenience in description, and thus, the substrate treating method may use an apparatus that is the same as or similar to the substrate treating apparatus 100. The substrate treating method may be provided in the form of a code or program for executing the substrate treating method, and be stored in a computer readable recording medium.

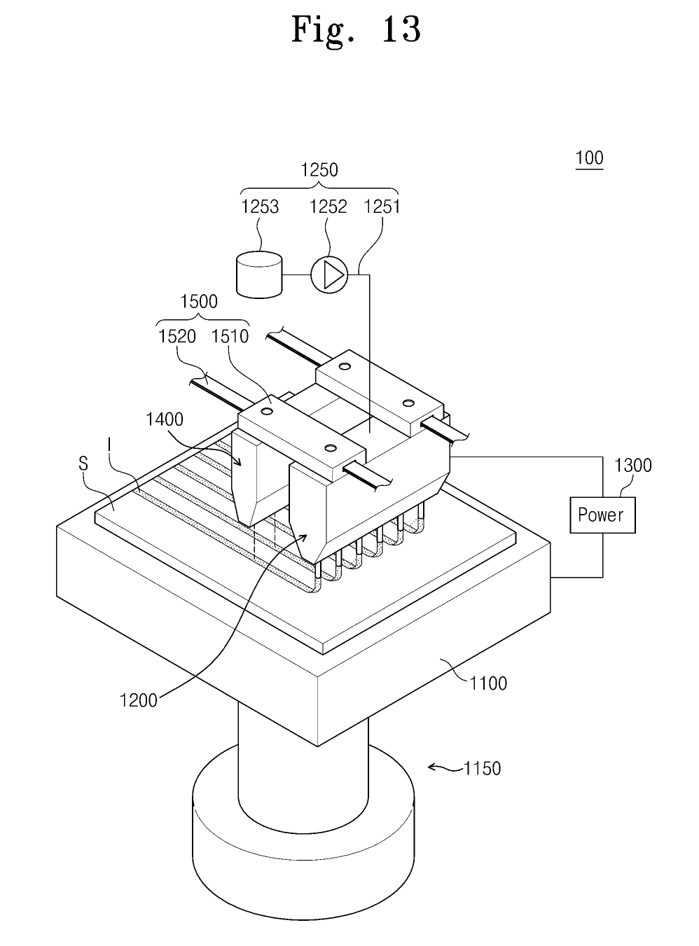

Hereinafter, a substrate treating method will now be described according to an embodiment of the present invention. FIG. 11 is a flowchart illustrating the substrate treating method according to the current embodiment.

The substrate treating method may include: operation S110 in which the substrate S is placed on the stage 1100; operation S120 in which the ink I is discharged; and operation S130 in which the ink I is solidified. Each operation will now be described in detail.

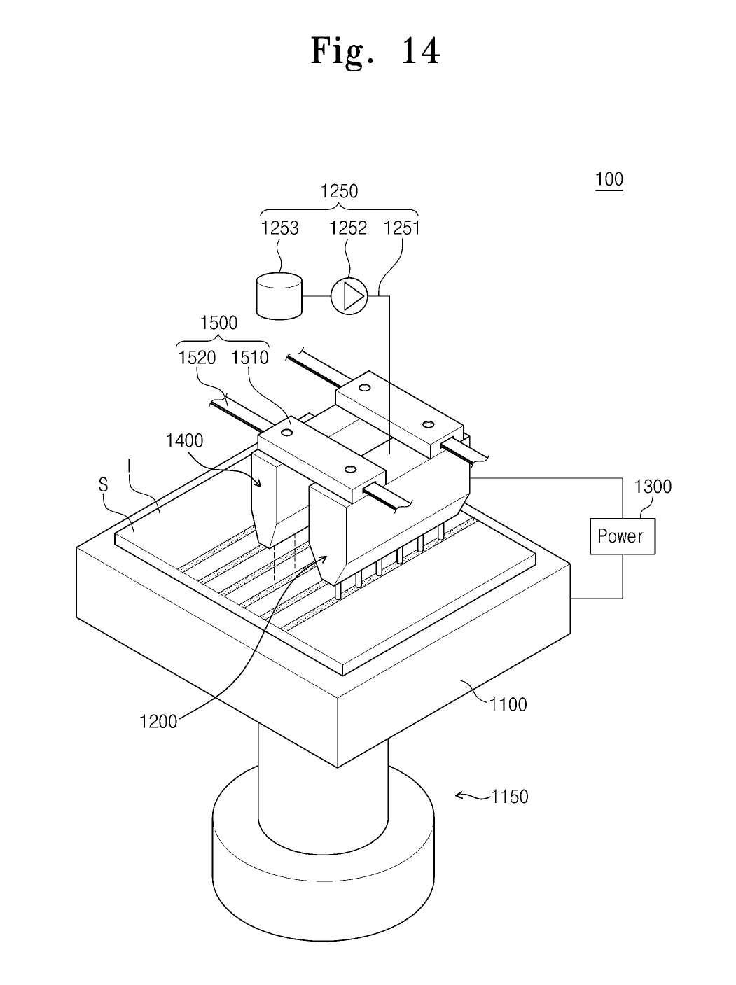

FIGS. 12 and 13 are perspective views illustrating the substrate treating method of FIG. 11.

Referring to FIG. 12, in operation S110, the substrate S is transferred from the outside of the substrate treating apparatus 100, and is placed on the stage 1100. For example, the substrate S may be transferred by one of an external robot, a roller, and various substrate transfer members.

Referring to FIG. 13, after the substrate S is placed on the stage 1100, the discharge unit 1200 discharges the ink I onto the substrate S in operation S120. While the discharge unit 1200 is horizontally moved by the transfer unit 1500, the discharge unit 1200 may discharge the ink I onto the top surface of the substrate S. Accordingly, lines may be formed on the top surface of the substrate S in a moving direction of the discharge unit 1200.

The solidifying unit 1400 may solidify the ink I in operation S 130. The solidifying unit 1400 may be moved by the transfer unit 1500 in the same direction as that of the transfer unit 1500. Since the solidifying unit 1400 is disposed behind the transfer unit 1500 in the moving direction, the solidifying unit 1400 may follow the transfer unit 1500. The solidifying unit 1400 may emit light to the lines formed from the discharged ink I. The irradiation members 1420 may be in one-to-one correspondence to the lines to emit light thereto. Alternatively, the irradiation member 1420 may emit light to a region corresponding to the width of all the lines.

When light is emitted to the ink I, a solvent is evaporated from the ink I, or the ink I is sintered, thereby solidifying the ink I. At this point, the solidifying unit 1400 following the discharge unit 1200 may solidify the discharged ink I at a predetermined time interval. Accordingly, a time interval from a point of time when the ink I is discharged to a point of time when the ink I is solidified is decreased. Thus, the ink I is prevented from being naturally dried, or external force applied to the substrate S is prevented from shaking the ink I discharged on the substrate S, thereby uniformly solidifying the ink I. When the ink I is uniformly solidified, the quality of circuit lines formed from the lines of the ink I can be improved. In addition, instead of solidifying the ink I after discharging the ink I, the ink I is discharged and solidified on the substrate S through a single process. Thus, a substrate process is simplified, thereby improving substrate throughput.

Further, the substrate treating method may include operation S140 in which the substrate S is rotated after the lines are formed, and operation S150 in which second lines are formed on the rotated substrate S in a direction different from that of the lines formed through operations S120 and S130 (hereinafter, referred to as first lines).

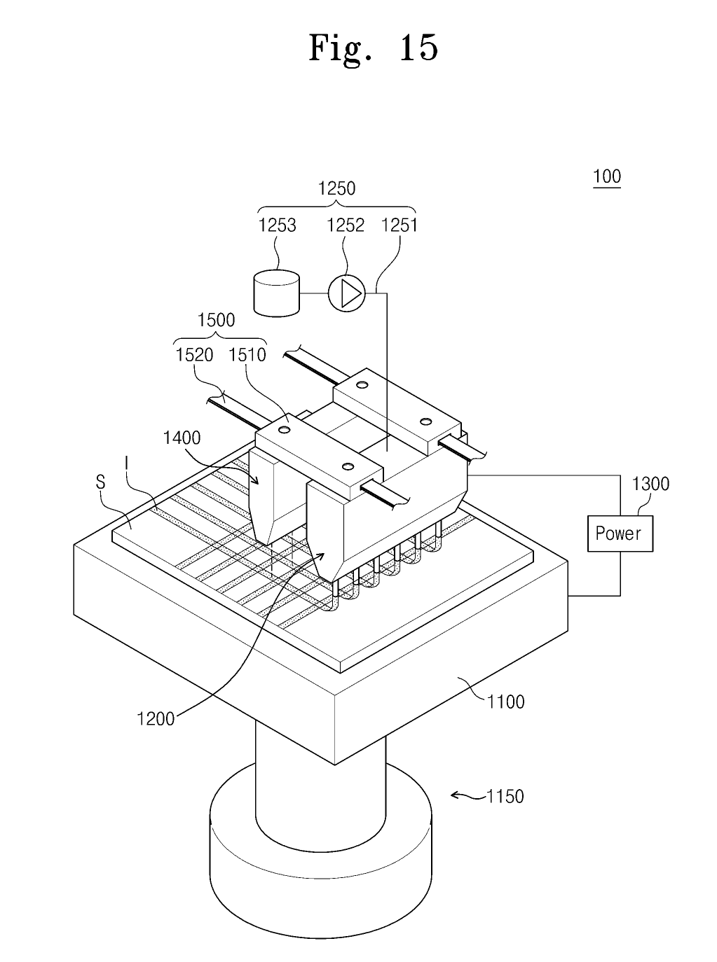

FIGS. 14 and 15 are perspective views illustrating subsequent processes of the substrate treating method of FIG. 11.

Referring to FIG. 14, after the first lines are formed, the rotation member 1150 may rotate the stage 1100 in operation S 140. For example, the stage 1100 may be rotated through about 90 degrees. Then, in plan view, a moving direction of the transfer unit 1500 may be perpendicular to the first lines formed on the substrate S.

Referring to FIG. 15, after the substrate S is rotated, the substrate treating apparatus 100 may form the second lines on the substrate S. For example, when the substrate S is rotated through about 90 degrees, the second lines may be formed in a direction perpendicular to the first lines. As in operations S120 and S130, the substrate treating apparatus 100 may discharge the ink I onto the substrate S and solidify the ink Ito form the second lines.

Accordingly, the second lines may be perpendicular to the first lines on the substrate S. For example, when a flat panel display is treated using the substrate treating method, two transparent electrode lines perpendicular to each other may be formed. In this case, one of the first and second lines may function as a gate electrode, and the other one may function as a source electrode.

According to the embodiments, a line is printed on a substrate by using a direct write method, thereby improving substrate throughput and significantly decreasing the using of chemicals.

In addition, since a line is formed and solidified through a single process by means of a solidifying unit following a discharge unit, a substrate can be quickly treated without using a separate solidifying process.

In addition, since a line is formed and solidified substantially at the same time, a time interval therebetween is minimized so as to prevent density deviation within a circuit line due to natural drying, thereby improving the quality of the circuit line.

However, the present invention is not limited thereto, and thus, other effects not described herein would be clearly understood by those skilled in the art from the above descriptions and the accompanying drawings.

The above-described embodiments are given so that those of skill in the related art could easily understand the present invention, and are not intended to limit the present invention.

Thus, the embodiments and elements thereof can be used in other ways or with known technology, and various modifications and changes in form and details can be made without departing from the scope of the present invention.

In addition, the scope of the present invention is defined by the following claims, and all differences within the scope will be considered as being included in the present invention.

What is claimed is:

1. A substrate treating apparatus comprising:
a stage on which a substrate is placed;
a discharge unit that discharges ink to form lines on the substrate placed on the stage;
a solidifying unit that solidifies the discharged ink; and
a transfer unit moving the stage or moving the discharge unit and the solidifying unit.

2. The substrate treating apparatus of claim 1, wherein the solidifying unit comprises an irradiation member that emits light.

3. The substrate treating apparatus of claim 2, wherein the irradiation member is provided in plurality, and the irradiation members are in one-to-one correspondence to the lines to emit the light thereto.

4. The substrate treating apparatus of claim 2, wherein the irradiation member is provided in a slit form having a width corresponding to a width of all the lines, and emits the light to a region corresponding to the width of all the lines.

5. The substrate treating apparatus of claim 2, wherein the irradiation member emits the light in a direction inclined from a vertical downward direction to a moving direction thereof.

6. The substrate treating apparatus of claim 2, wherein the irradiation member emits a laser or an ultraviolet ray.

7. The substrate treating apparatus of claim 1, wherein the discharge unit and the solidifying unit are arrayed in line in a moving direction thereof above the stage.

8. The substrate treating apparatus of claim 1, wherein the solidifying unit comprises a heating member that generates heat.

9. The substrate treating apparatus of claim 1, wherein the solidifying unit comprises a spraying member for spraying high temperature infusible particles or high temperature gas.

10. The substrate treating apparatus of claim 1, wherein the discharge unit comprises nozzles, each of which discharges the ink.

11. The substrate treating apparatus of claim 10, further comprising a power unit applying a high voltage to the discharge unit,
wherein the nozzles are provided in the form of a minute needle, and discharge the ink in a liquid column shape according to the high voltage by using an electrohydrodynamic method.

12. The substrate treating apparatus of claim 1, further comprising a rotation unit rotating the stage.

13. The substrate treating apparatus of claim 1, wherein the ink is conductive ink.

14. A substrate treating method comprising:
placing a substrate on a stage;
discharging ink by a discharge unit horizontally moving above the stage, to form first lines on the substrate placed on the stage; and
solidifying the discharged ink by a solidifying unit following the discharge unit.

15. The substrate treating method of claim 14, wherein in the solidifying of the discharge ink, light is emitted to the discharged ink to solidify the ink.

16. The substrate treating method of claim 15, wherein in the solidifying of the discharge ink, the light is emitted such that beams thereof are in one-to-one correspondence to the first lines.

17. The substrate treating method of claim 15, wherein in the solidifying of the discharge ink, the light is emitted to a region corresponding to a width of all the first lines.

18. The substrate treating method of claim 15, wherein in the solidifying of the discharge ink, the light is emitted in a direction inclined from a vertical downward direction to a moving direction thereof.

19. The substrate treating method of claim 14, further comprising applying a high voltage to the discharge unit,
wherein in the forming of the first lines, nozzles included in the discharge unit and provided in the form of a minute needle discharge the ink in a liquid column shape according to the high voltage by using an electrohydrodynamic method.

20. The substrate treating method of claim 14, further comprising:
rotating the stage through about 90 degrees;
discharging the ink by the discharge unit horizontally moving above the stage, to form second lines perpendicular to the first lines formed on the substrate; and
solidifying the second lines of the discharged ink by the solidifying unit following the discharge unit.
